(19) United States
(12) Patent Application Publication
(10) Pub. No.: US 2008/0250143 A1
(43) Pub. Date: Oct. 9, 2008

(54) GRID ACCOUNTING METHOD AND SYSTEM

(75) Inventors: Sukesh Garg, San Jose, CA (US); Frederick Lee, Foster City, CA (US)

Correspondence Address: THORNE & HALAJIAN;APPLIED TECHNOLOGY CENTER, 111 WEST MAIN STREET, BAY SHORE, NY, 11706, US

(73) Assignee: FRANCE TELECOM, Paris (FR)

(21) Appl. No.: 11/697,697

(22) Filed: Apr. 6, 2007

(51) Int. Cl. G06F 15/173

(52) U.S. Cl. 709/226

(57) ABSTRACT

A method is provided for accounting the usage of networked resources and/or services available for invocation in a grid computing architecture, said grid computing architecture including a grid middleware for invoking said services and/or resources, said method comprising the act of receiving at least one resource and/or one service available for invocation, retrieving through a database contract information related to said available resource and/or service, said contract comprising at least cost data for invoking said resource and/or service, collecting from the grid middleware a usage message, said usage message including usage information related to at least one service and/or resource that have been actually invoked on said grid middleware, and accounting the usage based on said usage message and the cost data from the contract information.

### BACKGROUND OF THE PRESENT SYSTEM

The present system relates to grid computing and, more particularly, to a grid computing accounting system and associated methodolgy for registering, managing and maintaining accounts of grid consumers.

The “background” description provided herein is for the purpose of generally presenting the context of the present system. Work of the presently named inventors, to the extent it is described in this background section, as well as aspects of the description which may not otherwise qualify as prior art at the time of filing, are neither expressly or impliedly admitted as prior art against the present system.

An executable service is a set of related executable functions which can be discovered or called (i.e., “programmatically invoked”) via an established network protocol. Such services include World Wide Web based services which are increasingly employed in carrying out the functions of composite applications. The leveraging of network distributed web services to function together as a composite application is referred to as grid computing or distributed object computing.

In operation, a grid computing architecture employs the web services as an application integration technology. Each web service is supported by a resource of the grid computing network. For example, in an Internet grid computing environment, individual web services may be supported by an execution environment, such as a corresponding web server. The information necessary to programmatically invoke the web service is defined in a Web Services Description Language (WSDL) document or Interface Definition Language (IDL) document. These documents are stored in a registry of the grid computing framework so that applications or users seeking subscription to a specific service can locate and invoke the necessary service. One well known type registry of web services is the Universal Description, Discovery and Integration (UDDI) registry. This registry type would include the location of the service and the necessary information for integrating this service in an application of the grid computing framework. Using the necessary information, an application or user can remotely call the service though an Extensible Mark-up Language (XML) based messaging protocol such as the Simple Object Acess Protocol (SOAP) or Object Request Broker (ORB) of the Common Object request broker Architecture (CORBA).

Grid computing has become popular as it appears as a computing model that provides the ability to perform at higher throughput levels when required and provide efficiency by taking advantage of a virtualized resource pool of servers, storage systems and a shared network infrastructure. At its very early age, Grid computing was considered as an academic initiative which accomplished compute intensive collaborative tasks for research activities. The most important issue, until recently, was investigating how to distribute a composite job, consisting of several subjobs, to several resources that can be invoked and scheduled appropriately. This is achieved through services and resources discovery. Efficient discovery of grid services and resources is an essential building block for a grid computing framework.

In order to achieve efficiency, computing resources on the Grid network should be available “on demand”. This means that there should be enough computing capacity available and users should only pay for the amount of cycles they consume. This is the key to achieve efficiency and cost savings for an enterprise. Therefore grid economics and accounting is becoming a subject of great importance for both the consumer (i.e. user or here after also called client) and the provider of grid computing.

In “GridBank: A Grid Accounting Services Architecture (GASA) for Distributed Systems Sharing and Integration” by Alexander Barmouta and Rajkumar Buyya, in Volume 16, No. 1, Springer Science and Business Media, USA, April 2006, a proprietary accounting system is presented. Queries about available resources are performed by a Grid Resource Broker (Nimrod/G from Buyya, R, Abramson, D, and Giddy, J (2000) in “Nimrod/G: An Architecture for a Resource Management and Scheduling System in a Global Computational Grid” for the Proceedings of the HPC ASIA 2000, the 4th International Conference on High Performance Computing in Asia-Pacific Region, Beijing, China, IEEE Computer Society Press). The Grid Resource broker supports scheduling based on the user's quality of service (QoS) requirements, such as computational deadline, budget, and optimization preference, and the access price of resources. The information is notably retrieved in a Grid Market Directory (GMD) which is a registry of available resources for invocation and augmented with the notion of a grid economy. In the Gridbank system, both the processing capacities and related costs are used to list resources available for grid computing.

GMD is a proprietary registry, which is not available to all grid users. Furthermore, Gridbank is not in compliance with the OGSA (Open Grid Services Architecture) grid architecture developed within the Open Grid Forum (OGF).

As a direct consequence, no common information model is readily proposed in Gridbank to exchange accounting information in an OGSA architecture.

Another drawback of the GMD is it utilizes static information about resources capacities, unlike the OGF compliant registry used by the Globus Toolkit's Monitoring and Discovery Service (MDS). In this latter registry, the information is dynamic and constantly updated with the current capacities of the resources available for invocation.

There is a need today for a non proprietary grid accounting system, in compliance with OGF requirements, and available to all grid users. There is a further need for a system which can rely upon a common information model for exchanging accounting information.

### SUMMARY OF THE PRESENT SYSTEM

In a first aspect of the present system, a method is provided for accounting the usage of networked resources and/or services available for invocation in a grid computing architecture, said grid computing architecture comprising a grid middleware for invoking said services and/or resources, said method comprising the acts of:

receiving at least one resource and/or one service available for invocation,

retrieving through a database contract information related to said available resource and/or service, said contract comprising at least cost data for invoking said resource and/or service,

collecting from the grid middleware a usage message, said usage message comprising usage information related the at least one service and/or resource that have been actually invoked on said grid middleware, and,

accounting the usage based on said usage message and the cost data from the contract information.

In a second aspect of the present system, a mediator interface is provided for accounting the usage of networked resources and/or services available for invocation in a grid computing architecture, said grid computing architecture comprising a grid middleware for invoking said services and/or resources, said mediator interface comprising an accounting Application Protocol Interface (API) configured to:

receive at least one resource and/or one service available for invocation,

retrieve through a database contract information related to said available resource and/or service, said contract comprising at least cost data for invoking said resource and/or service,

collect from the grid middleware a usage message, said usage message comprising usage information related to the at least one service and/or resource that has been invoked,

account the usage based on said usage message and the cost data from the contract information.

In a further aspect of the present system, a computer readable carrier is provided including computer program instructions that cause a computer to implement a method for accounting the usage of networked resources and/or services available for invocation in a grid computing architecture, said grid computing architecture comprising a grid middleware for invoking said services and/or resources, said computer readable carrier comprising:

instructions for receiving at least one resource and/or one service available for invocation,

instructions for retrieving through a database contract information related to said available resource and/or service, said contract comprising at least cost data for invoking said resource and/or service,

instructions for collecting from the grid middleware a usage message, said usage message comprising usage information related the at least one service and/or resource that have been actually invoked on said grid middleware, and,

instructions for accounting the usage based on said usage message and the cost data from the contract information.

In another aspect of the present system, a grid computing architecture is disclosed for accounting the usage of networked resources and/or services available for invocation, said grid computing architecture comprising a grid middleware for invoking said services and/or resources, said architecture comprising:

a grid information service node listing the networked resources and/or services available for invocation,

a client node configured to provide a service and/or resource query to said grid information service, and receive from said grid information service a list of services and/or resources answering said query, the client node being further configured to invoke any resource and/or services from said list through the grid middleware,

an accounting node having an Application Protocol Interface (API) configured to:
receive from said client node the list of services and/or resources,
retrieve through a database contract information related to list of resources and/or services, said contract comprising at least cost data for invoking said resource and/or service,
send the retrieved contract information to the client node,
collect from the grid middleware a usage message, said usage message comprising usage information related to the at least one service and/or resource that has been selected and invoked by the client based,
account the usage based on said usage message and the cost data from the contract information.

The architecture and interface according to the present system, here after referred to Grid Resource Bank, or GRB in short, provides a way to charge for resource and service usage. GRB is a platform independent Grid Service which can be used either as a stand alone service or component plugged into any Open Grid Service Architecture (OGSA) compliant Grid middleware. By platform independent, one may understand that Grid Resource Bank does not rely on any proprietary software (in contrast to Gridbank which relies on GMD and GridBus) and may be consumed by any entity which can understand standard Web Service protocol. Thus a true “on demand” grid service that may be invoked by a grid consumer, just like any other available services, is achieved.

GRB appears as a novel solution compatible with OGSA based architectures, and offers a flexible solution to the essential accounting requirements which are not covered yet by OGSA. As Gridbank is a proprietary solution, working intimately with GMD and Gridbus, these teachings cannot be applied to OGSA architectures.

It is to be understood that both the foregoing general description of the present system and the following detailed description are exemplary, but are not restrictive, of the present system.

### BRIEF DESCRIPTION OF THE SEVERAL VIEWS OF THE DRAWINGS

A more complete appreciation of the present system and many of the attendant advantages thereof will be readily obtained as the same becomes better understood by reference to the following detailed description when considered in connection with the accompanying drawings, wherein:

FIG. 1 is a high level block diagram of a computing architecture in accordance with an exemplary embodiment of the present system;

FIG. 2 is a more detailed block diagram of the computing architecture of the exemplary embodiment of FIG. 1;

FIG. 3 is a diagram describing the sequence of operations between the different elements of the exemplary embodiment of FIG. 1;

FIG. 4 is a process flow of the accounting method in accordance with an exemplary embodiment of the present system; and,

FIG. 5 is an exemplary information model suitable with the computing architecture in accordance with an exemplary embodiment of the present system.

### DETAILED DESCRIPTION OF THE PRESENT SYSTEM

Certain terminology used in the following description is for convenience only and is not limiting. The term “service” as used herein, is not limited exclusively to a single function, but embraces sets of related functionality. Likewise, the term “resource” as used herein is not limited to a single metric of a related service, but, instead, also embraces a set of metrics which describe the operating environment of the related service. In the drawings, the same reference numerals are used for designating the same or similar elements throughout the several figures.

The present system is related to a Grid Accounting service and system, which will be called here after “Resource Bank” or “Grid Resource Bank”, GRB in short. GRB offers a unified standard API for registering and managing the accounts of both a grid consumer (aka user) and a (resource and/or service) provider.

The “Account” refers to the identity, payment methods and contracts of a grid consumer or provider. GRB processes the account information by collecting resource usage record from the Grid middleware and correlating it to proper accounts and contracts. GRB may be seen as a service among all the services available for invocation in the grid architecture.

Grid computing provides a cost effect IT (Internet Technology) infrastructure for large scaled dynamic computing environment. Ongoing standardization efforts have brought flexibility and extensibility to the existing Grid architectures, allowing the cost benefits that are Grids promises. Open Grid Service Architecture (OGSA) is the result of industry wide efforts to define a standard common framework for Grid computing. If this standard defines many critical components, it does not so far cover one of the most important aspects of framework yet, i.e. accounting for the used services and resources.

By accounting in the context of the present system, one may understand the measurement of financial information resulting from resource and/or service allocation or usage in the grid environment. It comprises the measurement of the charge that will be billed to a grid consumer from usage of selected resources and/or services. Usage of a resource or a service may refer to the actual use of said resource or service once they have been invoked. This may comprise for instance the amount of time a resource or a service was used, the number of time if was used, if the charge is per use, . . . or any other datum related to the use of a service and/or a resource.

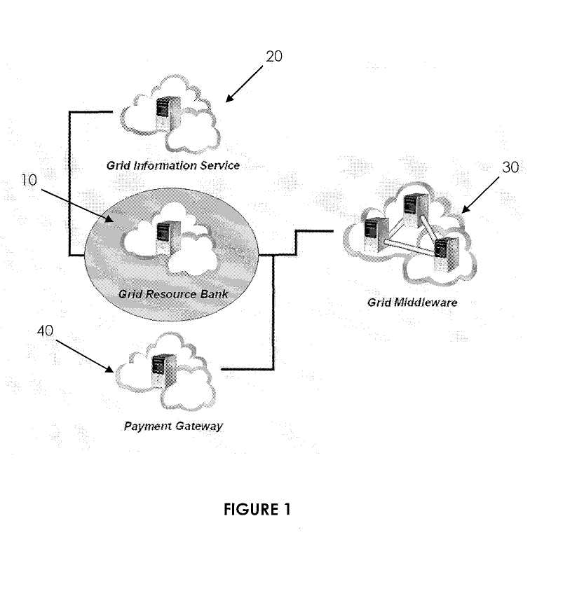

An exemplary embodiment of the architecture according to the present system is illustrated in FIG. 1. It comprises a grid information service 20, grid middleware 30 and a payment gateway 40, along GRB 10.

Grid Resource Bank 10 is a mediator interface that offers accounting services to any grid consumers. Interface 10 acts as a rendezvous interface that links the different components of the system according to the present system to perform accounting of grid resource usage. GRB can be seen as a service available for invocation in the grid environment.

Grid Information Service (GIS) is a service which allows the querying of a registry comprising a list of available services and/or resources on the grid environment. GIS offers APIs (Application Protocol Interface) to publish and inquire with respect to these web services and resources. These APIs are quite simple to use as the GIS registry itself is exposed as a web service using the Simple Object Application protocol (SOAP). Of course, those skilled in the art will recognize that other registries may employ alternative XML envelopes such as DIME, W3C and CORBA. UDDI (Universal Description, Discovery and Integration) and Globus MDS are good examples of a Grid Information Service and its related registry. Other examples are readily available to the man skilled in the art, such as e.g. a combination of UDDI and MDS registries. Such examples, unlike the known Grid Market Directory, are compatible with OGF standards. A grid consumer may find designated services and/or resources to be invoked based on consumer's criteria. GIS registry generally comprises the endpoint (i.e. address) wherefrom the service or the resource may be retrieved. This information is in-line with WSRF (Web Service Resource Framework) standard and correspond to a WS (Web Service) addressing properties which invoking a service or a resource. In fact, this addressing property may be used for any other purpose than finding the related resource or service. In the additional embodiment of the interface according to the present system, as explained later on, the endpoint may be used to retrieve the contract information.

Grid middleware 30 is typically an application server which virtualizes the inner details of service execution and resource utilization, which is also referred to in the present description as invocation.

Payment Gateway 40 is a proxy server which enables any third party to communicate with actual payment service such as Credit/Debit Card company and Bank.

As can be seen in FIG. 1, GRB sits in-between the three components 20, 30 and 40, and is isolated from Grid Middleware 30.

In the true service oriented grid environment, information about a service should be independent to any other services, and should not require any proprietary information. This is the only way to dynamically find desired services/resources and compose an aggregated service, i.e. invoke the found services/resources without conflict.

For Grid information service 20 to be truly loosely coupled with other components as the ones seen in FIG. 1, GIS 20 should not contain any meta-data other than the registered service itself. Therefore non-service meta-data information should only be requested by Grid information Service 20 from other sources, such as for example GRB.

To be consistent with a true service oriented grid environment, GRB needs to be an independent component of the Grid environment. In the system according to the present system, the Grid Middleware does not handle the accounting of used services and/or resources. This ensures that Grid Middleware 30 is agnostic to Payment Gateway 40 and other details and steps of the billing process.

Furthermore, GRB should only be added and invoked if necessary. To reach that goal, GRB 10 should be added to the current grid environment gracefully without modification of GIS 20 nor existing Grid Middleware 30. GRB and GIS should be ignorant of each other when it comes to their own needs, and GIS should work seamlessly without the need of GRB 10. No modification is required to the existing GIS (either MDS or UDDI registry for example) as it does not need to contain additional accounting information such as contracts, costs of usage, . . . that could be used by GRB 10. The same cannot be said of Gridbank and GMD wherein GMD contains accounting information and both cannot exist and work without the other one. They are “tightly” coupled.

GRB thus appears as a platform independent resource account and contracts management service. GRB can run as a standalone Grid Service or component within OGSA compliant Grid middleware. Platform independence of GRB brings flexibility to grids because it does not have to use any specific middleware.

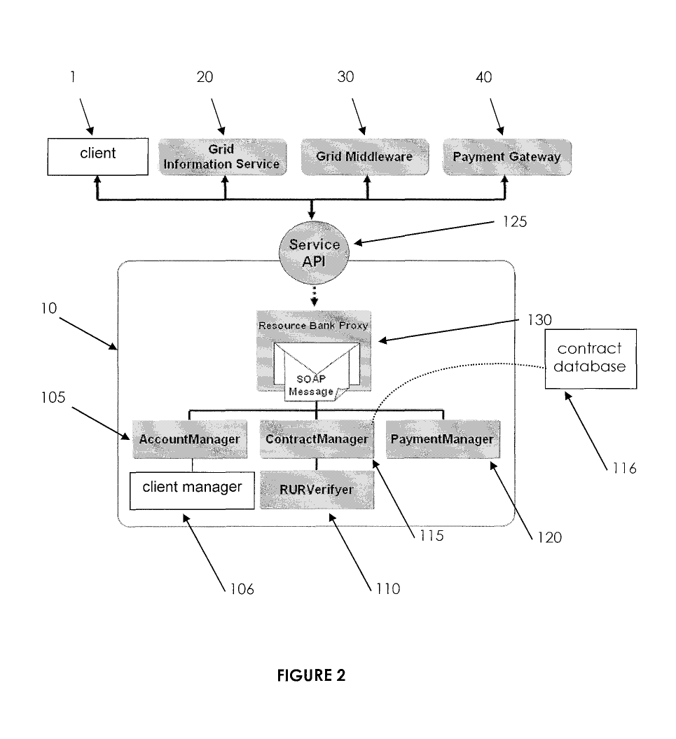

In the system according to the present system, GRB 10 and GIS 20 are “loosely” coupled. GRB 10 comprises or has access to a database (not shown in FIG. 1), independent of GIS 20, which contains the contract information for the services/resources of registry 20 as explained here after in relation to FIG. 2.

GRB 10 interfaces with the different components mentioned earlier, i.e., the GIS 20, grid middleware 30, and payment gateway 40. GRB is invoked by a consumer 1, i.e. a client, which can be either a service or a person. When invoking GRB 10, messages are passed on between the different components to an Application Program Interface (API) or service API 125 which interfaces between the different components and the consumer on one side, and the GRB on the other side. API 125 for example intercepts incoming XML envelopes, such as SOAP messages, coming from the different components of the system according to the present system and handles them depending on the stage of the method according to the present system.

GRB is hosted by a proxy server 130 wherein the related accounting service may be executed. Different elements are readily available to the proxy server 130 with which said proxy server 130 exchanges messages, such as SOAP (Simple Object Access Protocol) messages.

Among these different elements, one may find an account manager 105 which handles each resource account information. In the system according to the present system, each resource available for invocation may be identified by an account number. Account manager 105 may handle each account through for example the related account number, the name and address of the resource, its history of transactions, . . . The contract manager 115 is responsible for retrieving the contract related to the services and/or resources the consumer wants to invoke. Contract manager has access to a database 116 either within GRB 10 or remotely accessible that gathers all contracts. The retrieval may be achieved through the account number that identifies each resource.

Contracts may be available in contract database 116 upon registration for example. A link to the end point wherefrom the contract may be retrieved may also be stored in said database 116. Contracts define the rules to be applied when accounting for a resource and/or service usage in the grid environment. These rules may be referred to as cost data for invoking the resource and/or the service. Various forms of contracts may be defined, either consumer based i.e. depending on a consumer that may have negotiated special deals, and/or depending on the searched QoS (quality of service), time of usage, CPU available, promotions, or any combination thereof . . . Several contracts may also be attached to a single resource or a single service, depending on the consumer, or any other parameters. Contract information is used when GRB presents to the consumer the most interesting sources and/or services to invoke and when calculating the cost of usage of the invoked services and/or resources.

A new resource and/or service may register through GRB to receive a contract number and subsequently send contract information or a link to said contract so that contract itself or link may be stored in database 116. The registration may be similar to the way a service or a resource registers itself to GIS 20, the information passed on to GRB 10 comprising data to identify said service or resource as well as contract information. The information may be updated dynamically in database 116 once the contracts evolve or any data related to the resource or service account change. By dynamic, one may understand that the account information as well as the contract(s) handled by the account manager may be updated on a regular basis, for example when a new piece of information is available to GRB about registered resources and/or services.

For example, the state of a resource or service account may change over time from active (i.e. the resource/service is being used or is available for invocation), to due (i.e. the consumer has been charged with the usage of the resource/service and the charge is due), to suspended (e.g. after a delay is required in the payment) to closed (once the payment has been done) or any combination thereof.

The account information for a service or a resource may comprise owner credit information, like e.g. interest rates the owner may apply to delay payment, the owner's credit score, date of revision (i.e. last update of these information), . . . It may further comprise tax related information such as rate and exemption for tax report. Relationship/Link to other accounts for the same owner for example may also be specified in the account. The account for a resource or a service may be easily identified by an account number or any other identification method.

Such information may be updated dynamically and promptly, e.g. to make sure calculation of the charge is accurate and with the up to date resource and contract data.

GRB 10 may be seen in a way similar to GIS 20 as comprising a registry with contract information about resources and services available for invocation. GRB service may use a WSRF (Web Service Resource Framework) registry, similarly to the MDS registry, for maintaining the dynamic state of each account and providing a standardized way of accessing it.

GRB may further comprise a payment manager 120 to interact with the payment gateway 40 of FIG. 1. Payment manager 120 is for example in charge of handling the payment process based on the calculated cost of usage, and uses the consumer accounting information (mode of payment, chosen payment gateway, . . . ).

GRB may further comprise a usage verifying element 110 to authenticate the resource usage information coming from grid middleware 30. In one embodiment of the interface according to the present system, the usage message is a RUR (Resource Usage Record) message as described later on.

In an additional embodiment of the interface according to the present system, GRB may further handle consumers registration and identification, e.g. to correlate the consumer ID with specific contract information, like negotiated rates, or any other information that is consumer based. The way GRB utilizes a system to identify the client for the billing. Any method readily available to the man skilled in the art may be used to identify a consumer. For example, a secure method may use a Digital Certificate as an identity of a client/consumer. When a client chooses to invoke, i.e. use certain resources and/or services, this client may submit a Digital Certificate to the GRB as a proof of its identity and financial information (bank account or credit information). Digital Certificate then comprises the certified identity of this client and bank account associated with client. This may be implemented through a client manager 106 as seen in FIG. 2.

For accounting purposes, GRB mediates the communication between clients (i.e. grid consumers) and other Grid Services, such as payment gateway 40, an invoice service for invoicing (in compliance e.g. with NGOSS-share information data) or such as a credit information service (to verify the client credit information). With the abstraction layer (API 125) for a platform neutral Grid accounting service, all the participating components are agnostic to one another for accounting purposes. GRB will process any messages passing through it and hand it over to other components with an appropriate protocol understood by the respective service.

GRB provides an independent and single interface for Grid Services of the Grid environment. There is no need for other services to duplicate its own accounting service. No matter what Grid Information Services and Middleware are used in the grid environment, the client can rely upon a single accounting interface provided by the present system. As GRB interfaces with different components of the grid environment, different communication protocols may be readily available to GRB to communicate properly with said components.

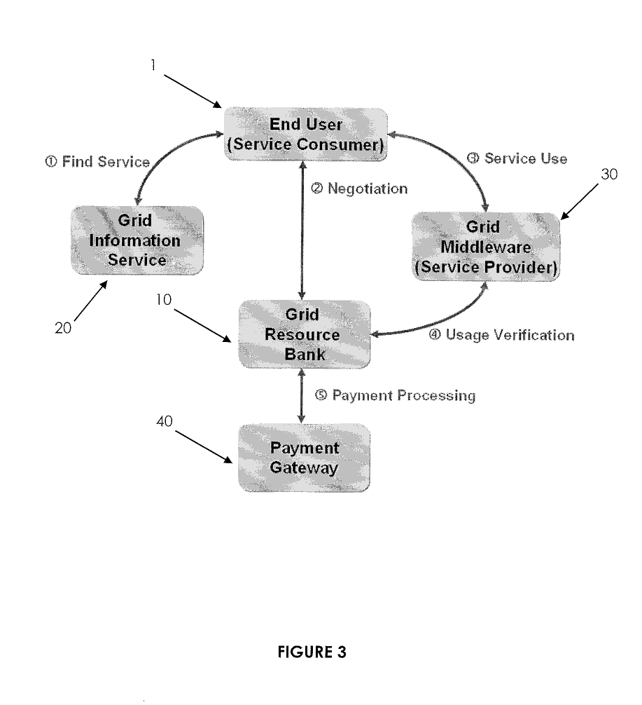

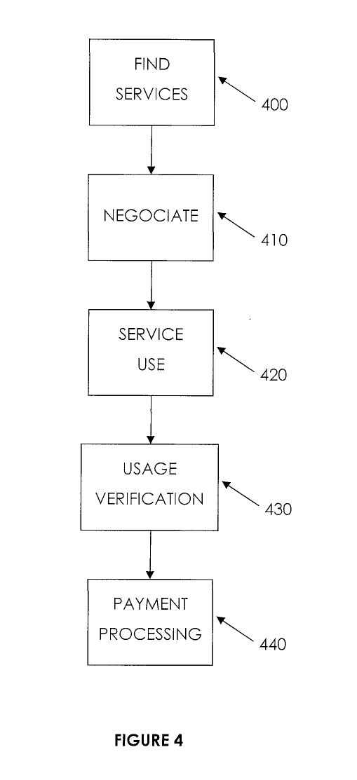

FIG. 3 is a diagram describing the sequence of operations between the different components of an exemplary embodiment of the system according to the embodiment illustrated in FIG. 1. The different acts of the method according to the present system are also illustrated on FIG. 4.

In a first act 400 of the method according to the present system, the client, i.e. the consumer 1 as seen in FIG. 3 sends a service and/or resource query message to Grid Information Service 20. The query message may comprise client's criteria to narrow down the resources and/or services to invoke.

GIS 20 returns a list of services and/or resources available for invocation, after processing the query parameters (corresponding to the client's criteria) such as, for example, CPU utilization, memory and storage usage. In addition, as mentioned earlier, GIS 20 also provides the endpoint of the contract for the resource wherein a selected service resides or for the selected service. The contract contains accounting and QoS related information which may be used at a negotiation stage.

In a further act 410, the client selects among the returned list of services and/or resources the most efficient ones through a negotiation act. Negociation act by client refers to the process of finding, i.e. selecting in said returned list, efficient grid resources (e.g., the most efficient) and/or services depending upon given characteristics of contract. Negociation act may be carried out when at least several resources are returned from GIS to the client. Negotiation is utilizes to confirm its availability and affordability accounting wise. For that matter, GRB, through contract manager 15 (as seen in FIG. 2), retrieves the contracts related to the list of services and/or resources returned in act 400 and provides the characteristics of said contracts to the client.

In an alternative act 410, the client may delegate the negociation to GRB, which may select suitable resources and/or services (e.g., most suitable) based on the client data and profile for example.

In the here after description of an exemplary embodiment of the method according to the present system, reference will be made to a service query and the related resources carrying said service. The man skilled in the art may easily generalize the hereafter teachings to the querying of services and/or resources a client may come up with when using GIS 20.

Upon the completion of the negotiation, the client selects one or more resources offering the queried service. In a further act 420, client invokes the service via the middleware through a batch process. Record of resource usage is stored in the grid middleware 30 and sent back to GRB 10.

Subsequently, in an optional act 430, the batch process in grid middleware 30 will send a usage verification message to GRB to confirm its validity. The act 430 may confirm that the usage of the queried resources is correct and is the right basis for charging the client. GRB will therefore verify said message and then proceed with the payment processing with payment gateway 40 in a further act 440. This act may, for example, comprise depositing credit onto service provider's account. GRB may then send an invoice to Payment Gateway using for example a common information model (SID GB922-2) and ask said gateway to execute a real billing process.

As described earlier, contract information may be stored within GRB, and more precisely in database 116 as shown in FIG. 2. Contract information is not stored nor shared with Grid information Service 20. This approach enables client 1 to communicate directly the accounting interface according to the present system without interacting with Grid Information Service 20 or Grid Middleware 30.

In order to facilitate compatibility (i.e. accounting) among diverse Grid Services, a defined common information model for all contracts may be used in the interface according to the present system. The registry for storing contracts may comprise for each contract one or more of the following:
account information (account of the resource provider/digital certificate of the owner),
payment methods offered or preferred by the resource owner (credit card, wire transfer, debit, . . . ),
payment options offered (one time/split/ . . . ),
payment strategies (payment before/after/as used),
resource promotion, different rate options,
economic model (auction/bid/ . . . )
payment gateway necessary or required,
QoS offered, for example depending on the CPU used, rate chosen,

Other information may be readily added by the man skilled in the art to enrich the GIS registry.

More generally, contract information may contain accounting and QoS information which will be used by the accounting interface according to the present system for negotiations with clients for all selected services and/or resources in GIS. On completion of service discovery, clients will get this contract information from GRB for all services and/or resources which satisfying the criteria of the query. The contract provides the economic value leading to the final decision for service and/or resource selection. This contract information may be presented to the client via for example XML encoding for ease of use and compatibility.

In order for resources and/or services usage to be charged, Grid Middleware 30 may exchange basic accounting and usage data in a common format. There is a technical working group under OGSA which is developing common information model (CIM) for record of resource usage called Resource Usage Record (RUR) mentioned earlier. RUR focuses on the representation of resource consumption data. RUR goes on to describe an XML-based format for usage records and is intended to be specific enough to facilitate information sharing among grid services. By leveraging this standard information model, GRB can get RUR from any Grid Middleware.

Thanks to usage messages such as a RUR message from Grid Middleware, GRB may calculate credit (i.e. cost) for resource usage by applying accounting and QoS constrains as known from the contract of the invoked resources and/or services. As each resource may have a distinct model for offering itself to a client and thereby a distinct model for generating revenue, the contract information in the interface according to the present system may be utilized for accounting the resource usage.

To complete the accounting process, GRB may send the billing information to Payment Gateway. However many commercial Payment Gateway services in today's marketplace are available, which means that it is almost impossible to interface with every Payment Gateway. In order to interface with any payment gateway, a common information model for billing and invoicing may be used in the interface according to the present system.

The billing information should contain all the data required to process money transactions along with auxiliary information to detail applied economy model and any given promotional facts.

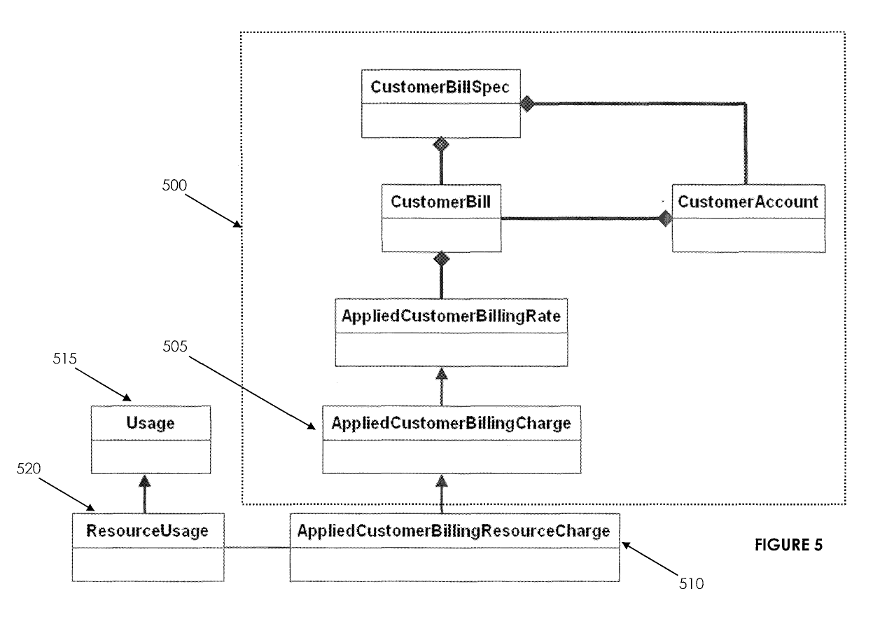

NGOSS SID GB922-2 addendum is a basic for information exchange used in the telecom business. FIG. 5 shows a basic information set in compliance with NGOSS SID GB922-2, slightly modified to fit Grid application requirement. The information within box 500 corresponds to the information commonly supported by NGOSS SID GB922-2 addendum. Nevertheless, as this common information model is used in the telecom business, it does not comprise any resource or service information. In the method according to the present system, this common information model is completed as follows to fit the need of the grid environment and support the information needed by a payment gateway. The “Applied Customer Billing Charge” box refers to billings and charges linked to phone calls in general or any other telecommunication charges. To introduce grid data, this “Applied Customer Billing Charge” box 505 is further completed with the charge related to the usage of an invoked resource and/or service (box 510 “applied customer billing resource charge” in FIG. 5), itself comprising information about resource usage (box 515, taken for example from RUR message and expression the need of resource and/or service) and usage itself (box 520).

Another significant advantage of using NGOSS SID model on billing and invoicing is that there are already many COTS (Commercial Off The Shelf) vendors who are compliant to NGOSS SID GB922-2 addendum.

One may note that the common information model described in relation to FIG. 5 is two-fold, i.e. it may be used both for the grid consumer as well as the grid provider.

Thanks to the mediator interface according to the present system, considerable cost savings and reduction of time to market is achieved for new grid based services by eliminating unnecessary software development efforts or software acquisition costs. The Resource Bank also provides a very simple and easy to use API, leveraging the best in class standard APIs and hiding the complexity of accounting processes from both the consumer and the provider. Another advantage of the interface according to the present system is the fact that through the negotiation of resources and services, the consumer may find the most interesting and cost saving resources to invoke, allowing economies of scales.

The man skilled in the art will understand that the foregoing description may be applied indifferently to service and resource invocation as they play a symmetric role for the Grid Resource Bank. Therefore, GRB may handle accounting for resource only utilization, service only execution or a combination of both. For example, when a client uses invokes a resource for execution its own service, resource usage may be charged. When a client is seeking a specific service, with or without a condition on the resources this service is running on (say for example running on resources with a Central Processing Unit utilization at less than 40%), GRB may handle the charging of the resource utilization only, the cost of the service only or a combination of both.

Obviously, readily discernible modifications and variations of the present system are possible in light of the above teachings. It is therefore to be understood that within the scope of the appended claims, the present system may be practiced otherwise than as specifically described herein. For example, while described in terms of hardware/software components interactively cooperating, it is contemplated that the system described herein may be practiced entirely in software. The software may be embodied in a carrier such as magnetic or optical disks, or a radio frequency or audio frequency carrier wave.

Thus, the foregoing discussion discloses and describes merely exemplary embodiments of the present system. As will be understood by those skilled in the art, the present system may be embodied in other specific forms without departing from the spirit or essential characteristics thereof. Accordingly, the disclosure of the present system is intended to be illustrative, but not limiting of the scope of the present system, as well as other claims. The disclosure, including any readily discernible variants of the teachings herein, define, in part, the scope of the foregoing claim terminology such that no inventive subject matter is dedicated to the public.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

What is claimed is:

1. A method for accounting the usage of networked resources and/or services available for invocation in a grid computing architecture, said grid computing architecture comprising a grid middleware for invoking said services and/or resources, said method comprising the act of:
receiving at least one resource and/or one service available for invocation,
retrieving through a database contract information related to said available resource and/or service, said contract comprising at least cost data for invoking said resource and/or service,
collecting from the grid middleware a usage message, said usage message comprising usage information related the at least one service and/or resource that have been actually invoked on said grid middleware,
accounting the usage based on said usage message and the cost data from the contract information.

2. The method of claim 1, said method further comprising after the retrieving act, the act of selecting at least one resource based on the retrieved contract information when a plurality of resources are received in the receiving act.

3. The method of claim 1, wherein contract information is stored in the database.

4. The method of claim 1, wherein a link to contract information is stored in the database.

5. The method of claim 1, wherein the usage message is a Resource Usage Record.

6. The method of claim 1, wherein the step of accounting the usage comprises the calculation of the cost for invoking the at least one service and/or resource.

7. The method of claim 1, further comprising the act of sending an accounting message to a payment gateway.

8. A mediator interface for accounting the usage of networked resources and/or services available for invocation in a grid computing architecture, said grid computing architecture comprising a grid middleware for invoking said services and/or resources, said mediator interface comprising an accounting Application Protocol Interface (API) configured to:
receive at least one resource and/or one service available for invocation,
retrieve through a database contract information related to said available resource and/or service, said contract comprising at least cost data for invoking said resource and/or service,
collect from the grid middleware a usage message, said usage message comprising usage information related to the at least one service and/or resource that has been invoked,
account the usage based on said usage message and the cost data from the contract information.

9. The mediator interface of claim 8, said mediator interface being invoked by a client of the grid computing architecture, the API being further configured to present to said client cost data related to the received at least one resource and/or service, when a plurality of available resources are received by said mediator interface.

10. The mediator interface of claim 8, wherein contract information is stored in the database.

11. The mediator interface of claim 8, wherein a link to contract information is stored in the database.

12. The mediator interface of claim 8, wherein the usage message is a Resource Usage Record.

13. The mediator interface of claim 8, wherein the API if further configured to calculate the cost for invoking the at least one service and/or resource.

14. The mediator interface of claim 8, wherein the API is further configured to send an accounting message to a payment gateway.

15. A computer readable carrier including computer program instructions that cause a computer to implement a method for accounting the usage of networked resources and/or services available for invocation in a grid computing architecture, said grid computing architecture comprising a grid middleware for invoking said services and/or resources, said computer readable carrier comprising:
instructions for receiving at least one resource and/or one service available for invocation,
instructions for retrieving through a database contract information related to said available resource and/or service, said contract comprising at least cost data for invoking said resource and/or service,
instructions for collecting from the grid middleware a usage message, said usage message comprising usage information related the at least one service and/or resource that have been actually invoked on said grid middleware,
instructions for accounting the usage based on said usage message and the cost data from the contract information.

16. The readable medium of claim 15, the computer program instructions being executed by a client of the grid computing architecture, the readable medium further comprising instructions to present to said client cost data related to the received at least one resource and/or service, when a plurality of available resources are received by said mediator interface.

17. The readable medium of claim 16, wherein the usage message is a Resource Usage Record.

18. The readable medium of claim 16, further comprising instructions to calculate the cost for invoking the at least one service and/or resource.

19. The readable medium of claim 16, further comprising instructions for sending an accounting message to a payment gateway.

20. A grid computing architecture for accounting the usage of networked resources and/or services available for invocation, said grid computing architecture comprising a grid middleware for invoking said services and/or resources, said architecture comprising:
a grid information service node listing the networked resources and/or services available for invocation,
a client node configured to provide a service and/or resource query to said grid information service, and receive from said grid information service a list of services and/or resources answering said query, the client node being further configured to invoke any resource and/or services from said list through the grid middleware,
an accounting node having an Application Protocol Interface (API) configured to:
receive from said client node the list of services and/or resources,
retrieve through a database contract information related to list of resources and/or services, said contract comprising at least cost data for invoking said resource and/or service,
send the retrieved contract information to the client node,
collect from the grid middleware a usage message, said usage message comprising usage information related to the at least one service and/or resource that has been selected and invoked by the client based,
account the usage based on said usage message and the cost data from the contract information.

21. The architecture of claim 20, wherein the client node selects the invoked resources and/or services based on the retrieved contract information.
